(19) United States
(12) Patent Application Publication
(10) Pub. No.: US 2012/0076552 A1
(43) Pub. Date: Mar. 29, 2012

(54) DEVELOPER SUPPLY DEVICE AND IMAGE FORMING APPARATUS HAVING THE SAME

(75) Inventors: Keisuke TAKAHASHI, Kasugai (JP); Kazuna TAGUCHI, Nagoya (JP)

(73) Assignee: BROTHER KOGYO KABUSHIKI KAISHA, Aichi (JP)

(21) Appl. No.: 13/240,762

(22) Filed: Sep. 22, 2011

(30) Foreign Application Priority Data
Sep. 24, 2010 (JP) 2010-213377

(51) Int. Cl. G03G 15/08

(52) U.S. Cl. 399/281

(57) ABSTRACT

A developer supply device configured to supply charged development agent to an intended device, includes a carrying assist member disposed, apart from a developer transfer path, to face a developer carrying surface of a developer carrying member at an upstream side relative to a developer carrying position, in which a transfer board is opposite and in closest proximity to the developer carrying surface, in a direction in which the developer carrying surface moves when the developer carrying member is driven to rotate. The carrying assist member is configured to, when a predetermined voltage is applied thereto, generate an electric field, under which the charged development agent heads for the developer carrying surface, between the carrying assist member and the developer carrying member.

### CROSS-REFERENCE TO RELATED APPLICATION

This application claims priority under 35 U.S.C. §119 from Japanese Patent Application No. 2010-213377 filed on Sep. 24, 2010. The entire subject matter of the application is incorporated herein by reference.

### BACKGROUND

1. Technical Field

The following description relates to one or more developer supply devices configured to supply charged powdered development agent to an intended device.

2. Related Art

A developer supply device has been known that includes a developer holding member and a transfer board.

The developer holding member is a roller-shaped member having a cylindrical circumferential surface parallel to a main scanning direction, and disposed to face an intended device. The transfer board includes a plurality of transfer electrodes arranged along a developer transfer path. The transfer board is configured to transfer development agent along the developer transfer path under a traveling-wave electric field generated when a multi-phase alternating-current (AC) voltage is applied to the transfer electrodes.

The transfer board includes a vertical transfer board and a bottom transfer board. The vertical transfer board extends vertically so as to transfer the development agent upward in the vertical direction. The developer holding member is disposed to face an upper end of the vertical transfer board. The bottom transfer board forms a bottom surface of a developer storage section. The bottom transfer board is configured to charge the development agent by friction between the bottom transfer board and the development agent, and to transfer the charged development agent toward a lower end of the vertical transfer board.

Further, a predetermined voltage is applied to between the vertical transfer board and the developer holding member so as to generate an electric field under which the charged development agent is transferred from the upper end of the vertical transfer board to the developer holding member.

In the developer supply device configured as above, the development agent is transferred upward in the vertical direction along the developer transfer path on the vertical transfer board. Then, in a position where the upper end of the vertical transfer board and the developer holding member face each other, the charged development agent is transferred onto the developer holding member by an action of the electric field generated when the predetermined voltage is applied. Namely, the development agent is held and carried on the circumferential surface of the developer holding member.

### SUMMARY

Aspects of the present invention are advantageous to provide one or more improved techniques for a developer supply device, which techniques allow the development agent to be held and carried on the circumferential surface of the developer holding member in a favorable manner.

According to aspects of the present invention, a developer supply device configured to supply charged development agent to an intended device is provided, which developer supply device includes a developer carrying member including a developer carrying surface that is formed as a cylindrical circumferential surface parallel to a first direction and disposed to be opposite and in closest proximity to the intended device in a first position, the developer carrying member being configured to rotate around an axis parallel to the first direction such that the developer carrying surface moves in a second direction perpendicular to the first direction and to feed the development agent carried on the developer carrying surface to the first position, a transfer board including a plurality of transfer electrodes arranged along a developer transfer path perpendicular to the first direction, the transfer board being configured to, when a transfer bias containing a multi-phase alternating-current voltage component is applied to the transfer electrodes, transfer the development agent along the developer transfer path to a second position where the transfer board is opposite and in closest proximity to the developer carrying surface, and a carrying assist member disposed, apart from the developer transfer path, to face the developer carrying surface in a third position upstream relative to the second position in the second direction, the carrying assist member being configured to, when a predetermined voltage is applied thereto, generate an electric field, under which the charged development agent heads for the developer carrying surface, between the carrying assist member and the developer carrying member.

According to aspects of the present invention, further provided is an image forming apparatus that includes a photoconductive body configured such that a development agent image is formed thereon, and a developer supply device configured to supply charged development agent to the photoconductive body. The developer supply device includes a developer carrying member including a developer carrying surface that is formed as a cylindrical circumferential surface parallel to a first direction and disposed to be opposite and in closest proximity to the photoconductive body in a first position, the developer carrying member being configured to rotate around an axis parallel to the first direction such that the developer carrying surface moves in a second direction perpendicular to the first direction and to feed the development agent carried on the developer carrying surface to the first position, a transfer board including a plurality of transfer electrodes arranged along a developer transfer path perpendicular to the first direction, the transfer board being configured to, when a transfer bias containing a multi-phase alternating-current voltage component is applied to the transfer electrodes, transfer the development agent along the developer transfer path to a second position where the transfer board is opposite and in closest proximity to the developer carrying surface, and a carrying assist member disposed, apart from the developer transfer path, to face the developer carrying surface in a third position upstream relative to the second position in the second direction, the carrying assist member being configured to, when a predetermined voltage is applied thereto, generate an electric field, under which the charged development agent heads for the developer carrying surface, between the carrying assist member and the developer carrying member.

### BRIEF DESCRIPTION OF THE ACCOMPANYING DRAWINGS

FIG. 1 is a side view schematically showing a configuration of a laser printer in an embodiment according to one or more aspects of the present invention.

FIG. 2 is an enlarged cross-sectional side view of a toner supply device for the laser printer in the embodiment according to one or more aspects of the present invention.

FIG. 3 is an enlarged cross-sectional side view of an electric-field transfer board for the toner supply device in the embodiment according to one or more aspects of the present invention.

FIG. 4 exemplifies a waveform of an output voltage generated by each power supply circuit for the electric-field transfer board in the embodiment according to one or more aspects of the present invention.

FIG. 5 is an enlarged cross-sectional side view of a toner supply device for the laser printer in a modification according to one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect.

Hereinafter, an embodiment according to aspects of the present invention will be described with reference to the accompanying drawings.

<Configuration of Laser Printer>

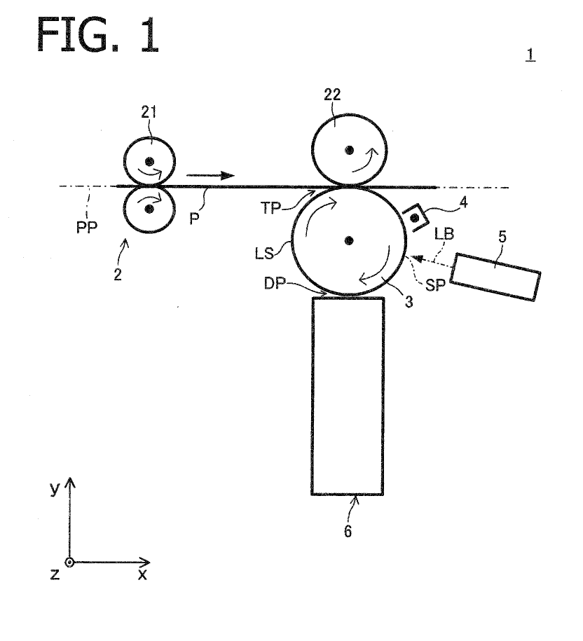

As illustrated in FIG. 1, a laser printer 1 includes a sheet feeding mechanism 2, a photoconductive drum 3, an electrification device 4, a scanning unit 5, and a toner supply device 6. A feed tray (not shown), provided in the laser printer 1, is configured such that a stack of sheets P is placed thereon. The sheet feeding mechanism 2 is configured to feed a sheet P along a predetermined sheet feeding path PP.

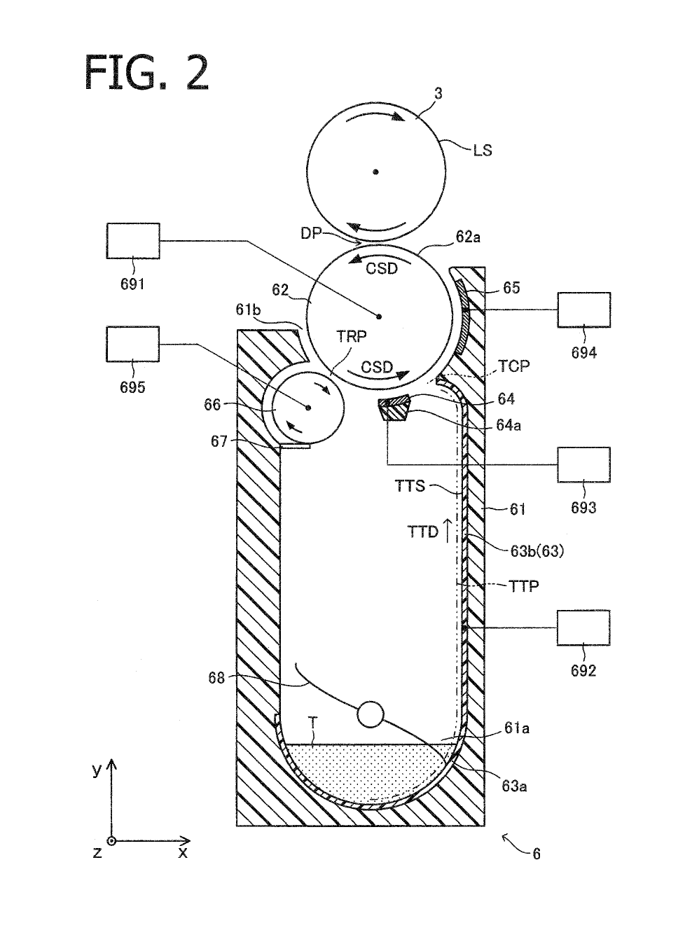

On a circumferential surface of the photoconductive drum 3, an electrostatic latent image carrying surface LS is formed as a cylindrical surface parallel to a main scanning direction (i.e., the z-axis direction in FIG. 1: hereinafter, which may be referred to as a “sheet width direction” as well). The electrostatic latent image carrying surface LS is configured such that an electrostatic latent image is formed thereon in accordance with an electric potential distribution. Further, the electrostatic latent image carrying surface LS is configured to hold toner T (see FIG. 2) in positions thereon corresponding to the electrostatic latent image. The photoconductive drum 3 is driven to rotate in the direction indicated by arrows (clockwise) in FIG. 1 around an axis parallel to the main scanning direction. Thus, the photoconductive drum 3 is configured to move the electrostatic latent image carrying surface LS along an auxiliary scanning direction (typically, the x-axis direction in FIG. 1) perpendicular to the main scanning direction.

The electrification device 4 is disposed to face the electrostatic latent image carrying surface LS. The electrification device 4, which is of a corotron type or a scorotron type, is configured to evenly and positively charge the electrostatic latent image carrying surface LS.

The scanning unit 5 is configured to generate a laser beam LB modulated based on image data. Specifically, the scanning unit 5 generates the laser beam LB within a predetermined wavelength range, which laser beam LB is emitted under ON/OFF control depending on whether there is a pixel in a target location on the image data. In addition, the scanning unit 5 converges the laser beam LB in a scanned position SP on the electrostatic latent image carrying surface LS, and forms the electrostatic latent image on the electrostatic latent image carrying surface LS, while moving (scanning) the position where the laser beam LB is converged on the electrostatic latent image carrying surface LS, along the main scanning direction at a constant speed. Here, the scanned position SP is located in a position downstream relative to the electrification device 4 and upstream relative to the toner supply device 6 in the moving direction of the electrostatic latent image carrying surface LS that moves along with rotation of the photoconductive drum 3.

The toner supply device 6 is disposed under the photoconductive drum 3 so as to face the electrostatic latent image carrying surface LS. The toner supply device 6 is configured to supply the charged toner T (see FIG. 2) onto (the electrostatic latent image carrying surface LS of) the photoconductive drum 3, in a development position DP. It is noted that the development position DP denotes a position where the toner supply device 6 faces the electrostatic latent image carrying surface LS in closest proximity thereto. A detailed explanation will be provided later about the configuration of the toner supply device 6.

Subsequently, a detailed explanation will be provided about a specific configuration of each element included in the laser printer 1.

The sheet feeding mechanism 2 includes a pair of registration rollers 21, and a transfer roller 22. The registration rollers 21 are configured to feed a sheet P toward between the photoconductive drum 3 and the transfer roller 22 at a predetermined moment. The transfer roller 22 is disposed to face the electrostatic latent image carrying surface LS across the sheet feeding path PP in a transfer position TP. Additionally, the transfer roller 22 is driven to rotate in a direction (counterclockwise) as indicated by an arrow in FIG. 1. The transfer roller 22 is connected with a transfer bias power supply circuit (not shown), such that a predetermined transfer bias is applied between the transfer roller 22 and the photoconductive drum 3 so as to transfer, onto the sheet P, the toner T (see FIG. 2) adhering onto the electrostatic latent image carrying surface LS.

<<Toner Supply Device>>

FIG. 2 is a cross-sectional side view (a cross-section along a plane with the main scanning direction as a normal line) of the toner supply device 6. As depicted in FIG. 2, a toner box 61, which forms a casing of the toner supply device 6, is formed as a substantially U-shaped box member when viewed in the z-axis direction. Further, the toner box 61 is disposed to have a longitudinal direction parallel to the vertical direction (i.e., the y-axis direction in FIG. 2).

The toner box 61 is configured to accommodate the toner T (dry-type powdered development agent). Specifically, the toner T is stored in a toner storage section 61a that is a substantially half-cylinder-shaped bottom space inside the toner box 61. It is noted that in the embodiment, the toner T is positively-chargeable nonmagnetic-one-component black toner.

Further, the toner box 61 has an opening 61b formed in a top position of the toner box 61 opposite the photoconductive drum 3. In other words, the opening 61b is provided to open up toward the photoconductive drum 3.

The development roller 62 is a roller-shaped member having a toner carrying surface 62a that is a cylindrical circumferential surface. The development roller 62 is disposed to face the photoconductive drum 3 in the development position DP. Specifically, the development roller 62 is disposed in a position where the toner carrying surface 62a faces the electrostatic latent image carrying surface LS of the photoconductive drum 3 across a predetermined distance of gap in the development position DP.

The development roller 62 is rotatably supported at an upper end portion of the toner box 61 where the opening 61b is formed. In the embodiment, the development roller 62 is disposed such that substantially a lower half of the toner carrying surface 62a is housed in the toner box 61 while substantially an upper half of the toner carrying surface 62a is exposed to the outside of the toner box 61.

Inside the toner box 61, an electric-field transfer board 63 is provided along a toner transfer path TTP, which is formed substantially in a J-shape having a longitudinal direction parallel to the vertical direction when viewed in the z-axis direction. The electric-field transfer board 63 is fixed onto an inner wall surface of the toner box 61. The electric-field transfer board 63 is configured to transfer the toner T with a traveling-wave electric field, on a toner transfer surface TTS along the toner transfer path TTP (a detailed explanation will be provided later about an internal configuration of the electric-field transfer board 63).

In the embodiment, the electric-field transfer board 63 includes an activating section 63a and a main transfer section 63b. The activating section 63a and the main transfer section 63b are formed in a J-shape, integrally in a seamless manner, when viewed in the z-axis direction.

The activating section 63a is fixed onto the inner wall surface of the toner box 61 in a bottom region of an inner space of the toner box 61. The activating section 63a is a hollow-shaped curved plate member that is curved in the shape of an upward-opened half-cylinder when viewed in the z-axis direction as shown in FIG. 2. Further, the activating section 63a is smoothly connected with a substantially flat-plate lower end of the main transfer section 63b, so as to smoothly transfer the toner T stored in the toner storage section 61a toward the lower end of the main transfer section 63b.

The main transfer section 63b is fixed onto the inner wall surface of the toner box 61, and extends vertically so as to transfer the toner T stored in the toner storage section 61a up toward the development roller 62. Specifically, a major part of the main transfer section 63b extends vertically upward from the lower end thereof connected with the activating section 63a. The main transfer section 63b is disposed such that an upper end thereof (i.e., a downstream end in a below-mentioned toner transfer direction TTD) faces the toner carrying surface 62a across a predetermined distance of gap in a toner carrying position TCP.

In the embodiment, the upper end of the main transfer section 63b is curved toward a lower end of the toner carrying surface 62a. Specifically, the upper end of the main transfer section 63b is formed substantially in an arc shape heading for the lower end of the toner carrying surface 62a when viewed in the z-axis direction, such that the toner T is made fly along a tangential direction (i.e., the horizontal direction in FIG. 2) at the lower end of the toner carrying surface 62a when viewed in the z-axis direction. Further, the upper end of the main transfer section 63b is configured with the toner transfer surface TTS facing down.

Thus, the electric-field transfer board 63 is configured to transfer the toner T stored in the toner storage section 61a in the toner transfer direction TTD toward the toner carrying position TCP, which is located upstream relative to the development position DP in the moving direction (hereinafter referred to as a “carrying surface moving direction CSD”) of the toner carrying surface 62a. It is noted that the toner transfer direction TTD is a tangential direction in a given position on the toner transfer path TTP, in which direction the toner T is transferred by the electric-field transfer board 63.

Further, in the embodiment, the toner carrying position TCP is disposed slightly downstream in the carrying surface moving direction CSD relative to a position that is symmetrically opposite to the development position DP with respect to a rotational center axis of the development roller 62 when viewed in the z-axis direction. Specifically, the toner carrying position TCP is located near a middle point of a virtual line segment that extends from a most-downstream end of the toner transfer path TTP in the toner transfer direction TTD (i.e., from a position corresponding to a most-downstream end of the main transfer section 63b in the toner transfer direction TTD) to a position intersecting with the toner carrying surface 62a, in the toner transfer direction TTD defined at the most-downstream end of the toner transfer path TTP.

Under the development roller 62, there is a carrying assist member 64 disposed inside the toner box 61, to face the toner carrying surface 62a in a position slightly upstream relative to the toner carrying position TCP in the carrying surface moving direction CSD. In other words, the carrying assist member 64 is disposed apart from the toner transfer path TTP. Specifically, the carrying assist member 64 is disposed substantially in a position directly below the development position DP.

In the embodiment, the carrying assist member 64 is an arc-shaped metal electrode plate that is configured to be concentric with the toner carrying surface 62a when viewed in the z-axis direction. In addition, the carrying assist member 64 is disposed to face the toner carrying surface 62a across a predetermined distance of gap over a wide range in the main scanning direction. The carrying assist member 64 is supported by a supporting member 64a that extends across a wide range in the main scanning direction inside the toner box 61.

There is an electrification assist electrode 65 disposed to face the toner carrying surface 62a in a position downstream relative to the toner carrying position TCP and upstream relative to the development position DP in the carrying surface moving direction CSD. The electrification assist electrode 65 is configured to charge the toner T carried on the toner carrying surface 62a by the action of an AC electric field generated between the electrification assist electrode 65 and the toner carrying surface 62a. In the embodiment, the electrification assist electrode 65 is an arc-shaped plate member that is configured to be concentric with the development roller 62 when viewed in the z-axis direction. Further, the electrification assist electrode 65 is formed from a metal plate such as a stainless steel plate. There is a predetermined distance of gap provided between the electrification assist electrode 65 and the toner carrying surface 62a.

In order to retrieve the toner T left on the toner carrying surface 62a even after passing through the development position DP, a retrieving member 66 is disposed to face the toner carrying surface 62a in a toner retrieving position TRP downstream relative to the development position DP and upstream relative to a position facing the carrying assist member 64 in the carrying surface moving direction CSD. Namely, the retrieving member 66 is disposed in such a position that a given point on the toner carrying surface 62a, after passing through the development position DP and entering into the toner box 61 via the opening 61b, faces the retrieving member 66 in advance of facing the carrying assist member 64.

In the embodiment, the retrieving member 66 is a roller member configured to rotate around an axis parallel to the main scanning direction. The retrieving member 66 is rotatably supported in such a position as to face an upper end of the inner wall surface of the toner box 61 on a side opposite the side where the electric-field transfer board 63 is supported. The retrieving member 66 is driven to rotate in a direction opposite to the rotational direction of the development roller 62, such that a circumferential surface of the retrieving member 66 moves in the same direction as the moving direction of the toner carrying surface 62a in the toner retrieving position TRP.

Beneath the retrieving member 66, a retrieving member cleaner 67 is disposed. The retrieving member cleaner 67 is configured to slide in contact with the circumferential surface of the retrieving member 66 while removing the toner T adhering onto the circumferential surface of the retrieving member 66 and dropping the removed toner T toward the toner storage section 61a.

In the bottom region of the inner space of the toner box 61, an agitator 68 is disposed. The agitator 68 is configured to, when driven to rotate, agitate the toner T in the toner storage section 61a.

<<<Internal Configuration of Transfer Board>>>

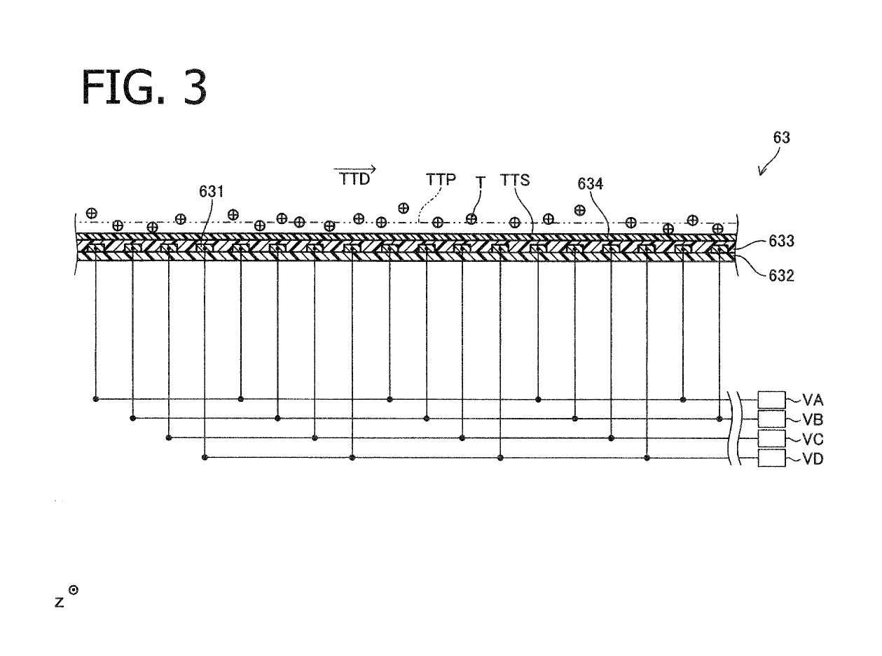

Referring to FIG. 3, the electric-field transfer board 63 is a thin plate member configured in the same manner as a flexible printed-circuit board. Specifically, the electric-field transfer board 63 includes a plurality of transfer electrodes 631, a supporting film layer 632, an electrode coating layer 633, and an overcoating layer 634.

The transfer electrodes 631 are linear wiring patterns that have a longitudinal direction parallel to the main scanning direction. For example, the transfer electrodes 631 may be formed with copper thin films. The transfer electrodes 631 are arranged along the toner transfer path TTP, to be parallel to each other.

Every fourth one of the transfer electrodes 631, arranged along the toner transfer path TTP, is connected with a specific one of four power supply circuits VA, VB, VC, and VD. In other words, the transfer electrodes 631 are arranged along the toner transfer path TTP in the following order: a transfer electrode 631 connected with the power supply circuit VA, a transfer electrode 631 connected with the power supply circuit VB, a transfer electrode 631 connected with the power supply circuit VC, a transfer electrode 631 connected with the power supply circuit VD, a transfer electrode 631 connected with the power supply circuit VA, a transfer electrode 631 connected with the power supply circuit VB, a transfer electrode 631 connected with the power supply circuit VC, a transfer electrode 631 connected with the power supply circuit VD, . . . . It is noted that the power supply circuits VA, VB, VC, and VD are included in a below-mentioned transfer bias supply circuit 692.

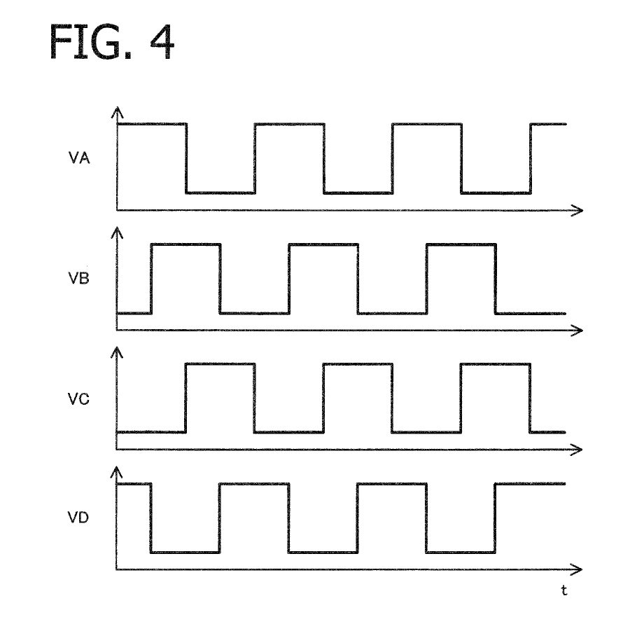

FIG. 4 exemplifies output waveforms, which are respectively generated by the power supply circuits VA, VB, VC, and VD shown in FIG. 3. In the embodiment, as illustrated in FIG. 4, the power supply circuits VA, VB, VC, and VD are configured to generate respective AC driving voltages having substantially the same waveform.

Further, the power supply circuits VA, VB, VC, and VD are configured to generate the respective AC driving voltages with a phase difference of 90 degrees between any adjacent two of the power supply circuits VA, VB, VC, and VD in the aforementioned order. In other words, the power supply circuits VA, VB, VC, and VD are configured to output the respective AC driving voltages each of which is delayed by a phase of 90 degrees behind the voltage output from a precedent adjacent one of the power supply circuits VA, VB, VC, and VD in the aforementioned order. Thus, the electric-field transfer board 63 is configured to transfer the positively charged toner T in the toner transfer direction TTD when the aforementioned driving voltages (transfer bias voltages) are applied to the transfer electrodes 631 and a traveling-wave electric field is generated along the toner transfer surface TTS.

The transfer electrodes 631 are formed on a surface of the supporting film layer 632. The supporting film layer 632 is a flexible film made of electrically insulated synthetic resin such as polyimide resin. The electrode coating layer 633 is made of electrically insulated synthetic resin. The electrode coating layer 633 is provided to coat the transfer electrodes 631 and a surface of the supporting film layer 632 on which the transfer electrodes 631 are formed.

On the electrode coating layer 633, the overcoating layer 634 is provided. Namely, the electrode coating layer 633 is formed between the overcoating layer 634 and the transfer electrodes 631. The surface of the overcoating layer 634 (i.e., the toner transfer surface TTS) is formed as a smooth surface with a very low level of irregularity, so as to smoothly convey the toner T.

<<<Bias Supply Unit>>>

Referring back to FIG. 2, the development roller 62 is electrically connected with a development bias supply circuit 691. The development bias supply circuit 691 is configured to output a voltage that is required for applying a development bias (containing a direct-current (DC) voltage component and an AC voltage component) for causing a so-called jumping phenomenon, between the development roller 62 and the photoconductive drum 3 (more exactly, between the toner carrying surface 62a and exposed portions having an electric potential VL on the electrostatic latent image carrying surface LS).

The electric-field transfer board 63 is electrically connected with the transfer bias supply circuit 692. The transfer bias supply circuit 692 is configured to apply, to the transfer electrodes 631 (see FIG. 3), the transfer bias containing a multi-phase AC voltage component (see FIG. 4) for conveying the toner T to the toner carrying position TCP along the toner transfer path TTP.

The carrying assist member 64 is electrically connected with a carrying assist bias supply circuit 693. The carrying assist bias supply circuit 693 is configured to output a voltage required for applying a carrying assist bias (i.e., a voltage for generating an electric field under which the positively charged toner T heads for the toner carrying surface 62a) between the development roller 62 and the carrying assist member 64.

The electrification assist electrode 65 is electrically connected with an electrification assist bias supply circuit 694. The electrification assist bias supply circuit 694 is configured to output a voltage required for applying an electrification assist bias (i.e., an AC voltage for generating an AC electric field under which the toner T on the toner carrying surface 62a is further charged) between the development roller 62 (the toner carrying surface 62a) and the electrification assist electrode 65.

The retrieving member 66 is electrically connected with a retrieving bias supply circuit 695. The retrieving bias supply circuit 695 is configured to output a voltage required for applying a retrieving bias (i.e., a voltage for generating such an electric field that the positively charged toner T is attracted toward the retrieving member 66) between the development roller 62 and the retrieving member 66.

<<<<Concrete Example of Bias>>>>

In the embodiment, specifically, the development roller 62 is an aluminum roller with a diameter of 20 mm. The development bias supply circuit 691 is configured to output a voltage (−1100 V to +1500 V) containing a DC voltage component of +200 V and an AC voltage component with an amplitude of 1300 V and a frequency of 1 kHz.

There is a gap of 1 mm provided in the toner carrying position TCP between the development roller 62 (the toner carrying surface 62a) and the downstream end of the electric-field transfer board 63 in the toner transfer direction TTD. The transfer bias supply circuit 692 is configured to output the transfer bias (+200 V to +800 V) containing a DC voltage component of +500 V and a four-phase AC voltage component with an amplitude of 300 V and a frequency of 300 Hz.

There is a gap of 2 mm provided between the development roller 62 (the toner carrying surface 62a) and the carrying assist member 64.

The electrification assist electrode 65 is formed from a stainless steel plate that is as long as 9 mm and bent substantially in an arc shape when viewed in the z-axis direction. There is a gap of 0.3 mm provided between the development roller 62 (the toner carrying surface 62a) and the electrification assist electrode 65. The electrification assist bias supply circuit 694 is configured to output a DC voltage of +340 V.

The retrieving member 66 is an aluminum roller with a diameter of 12 mm. There is a gap of 0.5 mm provided between the development roller 62 (the toner carrying surface 62a) and the retrieving member 66. The retrieving bias supply circuit 695 is configured to output a DC voltage of −100 V.

<Operations of Laser Printer>

Subsequently, a general overview of operations by the laser printer 1 configured as above will be provided with reference to the relevant drawings.

<<Sheet Feeding Operation>>

Referring to FIG. 1, firstly, a leading end of a sheet P placed on the feed tray (not shown) is fed to the registration rollers 21. The registration rollers 21 perform skew correction for the sheet P, and adjust a moment when the sheet P is to be fed forward. After that, the sheet P is fed to the transfer position TP.

<<Toner Image Formation on Electrostatic Latent Image Carrying Surface>>

While the sheet P is being conveyed to the transfer position TP as described above, an image of the toner T (hereinafter referred to as a toner image) is formed on the electrostatic latent image carrying surface LS that is the outer circumferential surface of the photoconductive drum 3, as will be mentioned below.

<<Formation of Electrostatic Latent Image>>

Firstly, the electrostatic latent image carrying surface LS of the photoconductive drum 3 is charged evenly and positively by the electrification device 4. The electrostatic latent image carrying surface LS, charged by the electrification device 4, is moved along the auxiliary scanning direction to the scanned position SP to face the scanning unit 5, when the photoconductive drum 3 rotates in the clockwise direction shown by arrows in FIG. 1.

In the scanned position SP, the electrostatic latent image carrying surface LS is exposed to the laser beam LB that is modulated based on the image data. Namely, while being scanned along the main scanning direction, the laser beam LB is rendered incident onto the electrostatic latent image carrying surface LS. In accordance with the modulation of the laser beam LB, areas with no positive charge remaining thereon are generated on the electrostatic latent image carrying surface LS. Thereby, an electrostatic latent image is formed with a positive charge pattern (positive charges distributed in the shape of an image) on the electrostatic latent image carrying surface LS. The electrostatic latent image, formed on the electrostatic latent image carrying surface LS, is transferred to the development position DP to face the toner supply device 6 when the photoconductive drum 3 rotates in the clockwise direction indicated by the arrows in FIG. 1.

<<Transfer and Supply of Charged Toner>>

Referring to FIGS. 2 and 3, the toner T stored in the toner box 61 is charged due to contact and/or friction with the overcoating layer 634 on the activating section 63a. The charged toner T, which is in contact with or proximity to the overcoating layer 634 on the activating section 63a, is conveyed in the toner transfer direction TTD, by the traveling-wave electric field generated when the aforementioned transfer bias is applied to the transfer electrodes 631 of the activating section 63a. Thereby, the charged toner T is smoothly transferred to the main transfer section 63b.

The main transfer section 63b conveys the toner T, received at the lower end of the main transfer section 63b from the activating section 63a, vertically up toward toner carrying position TCP, by the traveling-wave electric field generated when the aforementioned transfer bias is applied to the transfer electrodes 631 of the main transfer section 63b.

Here, the toner T transferred from the activating section 63a to the main transfer section 63b contains toner charged in an undesired manner as well (e.g., inadequately charged toner and uncharged toner). Nonetheless, in the embodiment, inappropriately charged toner leaves the toner transfer path TTP and drops from the main transfer section 63b when being conveyed vertically up toward the toner carrying position TCP by the main transfer section 63b.

Thereby, it is possible to selectively convey adequately charged toner T to the toner carrying position TCP. Namely, it is possible to discriminate adequately-charged toner T from inappropriately-charged toner T on the main transfer section 63b. The toner T, which has left the toner transfer path TTP and dropped, returns into the toner storage section 61a.

In the aforementioned manner, the positively charged toner T is transferred to the toner carrying position TCP by the main transfer section 63b. During this time period, a charged level (the amount of the charges) of the toner T gradually rises due to contact or collision between the toner T and the toner transfer surface TTS.

The toner T, transferred to the toner carrying position TCP by the main transfer section 63b, is held and carried on the toner carrying surface 62a in the vicinity of the toner carrying position TCP, by the action of the transfer bias and the development bias (more specifically, by the action of the electric field generated by an electric potential difference between the development roller 62 and the transfer electrodes 631 which difference is formed by the transfer bias and the development bias). The toner T carried on the toner carrying surface 62a is evenly charged by the action of the AC electric field between the development roller 62 and the electrification assist electrode 65.

Then, when the development roller 62 is driven to rotate and the toner carrying surface 62a moves to the development position DP, the toner T is supplied to the development position DP. In the vicinity of the development position DP, the electrostatic latent image formed on the electrostatic latent image carrying surface LS is developed with the toner T by the action of the development bias. Namely, the toner T is transferred from the toner carrying surface 62a, and adheres to the areas with no positive charge on the electrostatic latent image carrying surface LS. Thereby, the toner image (i.e., the image of the toner) is formed and carried on the electrostatic latent image carrying surface LS.

The toner T, which remains on the toner carrying surface 62a (without being consumed in the development position DP) after passing through the development position DP, is retrieved by the retrieving member 66 in the vicinity of the toner retrieving position TRP. Thereby, a record of the development of the electrostatic latent image in the development position DP is cleared in a favorable manner. Thus, it is possible to prevent a ghost image from emerging in the formed image, as effectively as practicable. The toner T, adhering onto the circumferential surface of the retrieving member 66, is removed from the circumferential surface of the retrieving member 66 by the retrieving member cleaner 67, and drops into the toner storage section 61a.

<<Transfer of Toner Image from Electrostatic Latent Image Carrying Surface onto Sheet>>

Referring to FIG. 1, the toner image, which is carried on the electrostatic latent image carrying surface LS of the photoconductive drum 3 as described above, is conveyed to the transfer position TP when the electrostatic latent image carrying surface LS turns in the clockwise direction shown by the arrows in FIG. 1. Then, in the transfer position TP, the toner image is transferred from the electrostatic latent image carrying surface LS onto the sheet P.

<Effects>

In the embodiment, the major part of the main transfer section 63b (other than the upper end thereof) is configured to convey the toner T vertically upward. Further, the upper end of the main transfer section 63b is configured such that the toner transfer surface TTS thereof faces downward. Namely, the upper end of the main transfer section 63b is configured to convey the toner T on the down-facing surface thereof. Thereby, it is possible to discriminate adequately-charged toner T from inappropriately-charged toner T in a favorable manner.

Further, in the embodiment, such an electric field as to convey the positively-charged toner T from the carrying assist member 64 toward the toner carrying surface 62a of the development roller 62 is generated between the development roller 62 and the carrying assist member 64 that is disposed to face the toner carrying surface 62a in the position upstream relative to the toner carrying position TCP in the carrying surface moving direction CSD. The electric field acts on the toner T that has jumped from the electric-field transfer board 63 so as to make the toner T head for the toner carrying surface 62a in the vicinity of the toner carrying position TCP. Namely, the electric field assists the toner T to be carried on toner carrying surface 62a in the vicinity of the toner carrying position TCP.

Thereby, the toner T is carried on the toner carrying surface 62a in a more favorable manner. Specifically, it is possible to prevent the toner T, which has jumped from the downstream end of the main transfer section 63b in the toner transfer direction TTD, from heading in a direction (e.g., a direction toward the retrieving member 66) opposite to the direction toward the toner carrying surface 62a, as effectively as practicable.

Especially, according to the embodiment, when the gap in the toner carrying position TCP between the toner carrying surface 62a and the main transfer section 63b is rendered wider so as to make the toner T more evenly carried on the toner carrying surface 62a, it is possible to effectively prevent the toner T, which has jumped from the downstream end of the main transfer section 63b in the toner transfer direction TTD, from heading for the retrieving member 66 or drifting in the toner box 61 without heading for the toner carrying surface 62a.

Hereinabove, the embodiment according to aspects of the present invention has been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

Only an exemplary embodiment of the present invention and but a few examples of their versatility are shown and described in the present disclosure. It is to be understood that the present invention is capable of use in various other combinations and environments and is capable of changes or modifications within the scope of the inventive concept as expressed herein. For example, the following modifications are feasible.

<Modifications>

Aspects of the present invention may be applied to electrophotographic image forming devices such as color laser printers, and monochrome and color copy machines, as well as the single-color laser printer as exemplified in the aforementioned embodiment. Further, the photoconductive body is not limited to the drum-shaped one as exemplified in the aforementioned embodiment. For instance, the photoconductive body may be formed in the shape of a plate or an endless belt.

Additionally, light sources (e.g., LEDs, electroluminescence devices, and fluorescent substances) other than a laser scanner may be employed as light sources for exposure. In such cases, the “main scanning direction” may be parallel to a direction in which light emitting elements such as LEDs are aligned. Alternatively, aspects of the present invention may be applied to image forming devices employing methods other than the aforementioned electrophotographic method (e.g., a toner-jet method, an ion flow method, and a multi-stylus electrode method that do not use any photoconductive body).

The photoconductive drum 3 may contact the development roller 62. Further, the development roller 62 may contact the retrieving member 66.

The aforementioned various biases may be changed as needed. For instance, referring to FIG. 4, each transfer bias generated by the power supply circuits VA, VB, VC, and VD may have an arbitrary waveform (e.g., a sinusoidal waveform and a triangle waveform) other than the rectangle waveform as exemplified in the aforementioned embodiment. Further, in the aforementioned embodiment, the four power supply circuits VA, VB, VC, and VD are provided to generate the respective transfer bias voltages with a phase difference of 90 degrees between any adjacent two of the power supply circuits VA, VB, VC, and VD in the aforementioned order (four phases). However, three power supply circuits may be provided to generate respective transfer bias voltages with a phase difference of 120 degrees between any two of the three power supply circuits.

The electric-field transfer board 63 may be configured without the overcoating layer 634.

A central portion of the activating section 63a may be flat. Namely, the activating section 63a may have a curved portion only at a joint where the activating section 63a is connected with the lower end of the main transfer section 63b. The main transfer section 63b may be slightly slanted as far as it extends substantially in the vertical direction.

The activating section 63a may be configured as a board separate from the main transfer section 63b. In this case, the activating section 63a and the main transfer section 63b may be connected with respective different power supply circuits.

The toner T may not necessarily be charged by the entire toner transfer path TTP. For instance, the material for the overcoating layer 634 of the main transfer section 63b may appropriately selected so as to restrain, as effectively as practicable, the toner T from being charged up while being conveyed on the main transfer section 63b.

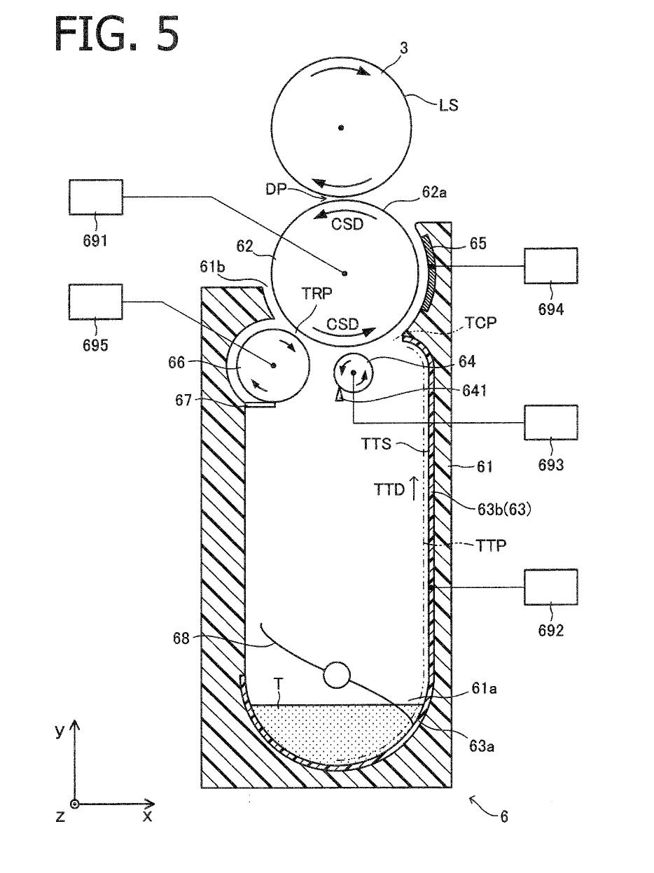

Further, as shown in FIG. 5, the carrying assist member 64 may be configured with a roller-shaped member configured to rotate around an axis parallel to the main scanning direction. In this case, a cleaning member 641 may be provided to clean a circumferential surface of the carrying assist member 64.

Further, the configurations of the electrification assist electrode 65 and the retrieving member 66 are not limited to those exemplified in the aforementioned embodiment. For example, the retrieving member 66 may be formed from a metal plate.

What is claimed is:

1. A developer supply device configured to supply charged development agent to an intended device, comprising:
a developer carrying member comprising a developer carrying surface that is formed as a cylindrical circumferential surface parallel to a first direction and disposed to be opposite and in closest proximity to the intended device in a first position,
wherein the developer carrying member is configured to rotate around an axis parallel to the first direction such that the developer carrying surface moves in a second direction perpendicular to the first direction and to feed the development agent carried on the developer carrying surface to the first position;
a transfer board comprising a plurality of transfer electrodes arranged along a developer transfer path perpendicular to the first direction,
wherein the transfer board is configured to, when a transfer bias containing a multi-phase alternating-current voltage component is applied to the transfer electrodes, transfer the development agent along the developer transfer path to a second position where the transfer board is opposite and in closest proximity to the developer carrying surface; and
a carrying assist member disposed, apart from the developer transfer path, to face the developer carrying surface in a third position upstream relative to the second position in the second direction,
wherein the carrying assist member is configured to, when a predetermined voltage is applied thereto, generate an electric field, under which the charged development agent heads for the developer carrying surface, between the carrying assist member and the developer carrying member.

2. The developer supply device according to claim 1, further comprising a retrieving member disposed to face the developer carrying surface in a fourth position downstream relative to the first position and upstream relative to the third position in the second direction, and
wherein the retrieving member is configured to, when a predetermined voltage is applied thereto, to generate an electric field, under which the charged development agent is attracted toward the retrieving member, between the retrieving member and the developer carrying surface and to retrieve the development agent left on the developer carrying surface after passing through the first position.

3. The developer supply device according to claim 1,
wherein the carrying assist member comprises a roller-shaped member configured to rotate around an axis parallel to the first direction.

4. An image forming apparatus comprising:
a photoconductive body configured such that a development agent image is formed thereon; and
a developer supply device configured to supply charged development agent to the photoconductive body,
wherein the developer supply device comprises:
a developer carrying member comprising a developer carrying surface that is formed as a cylindrical circumferential surface parallel to a first direction and disposed to be opposite and in closest proximity to the photoconductive body in a first position,
wherein the developer carrying member is configured to rotate around an axis parallel to the first direction such that the developer carrying surface moves in a second direction perpendicular to the first direction and to feed the development agent carried on the developer carrying surface to the first position;
a transfer board comprising a plurality of transfer electrodes arranged along a developer transfer path perpendicular to the first direction,
wherein the transfer board is configured to, when a transfer bias containing a multi-phase alternating-current voltage component is applied to the transfer electrodes, transfer the development agent along the developer transfer path to a second position where the transfer board is opposite and in closest proximity to the developer carrying surface; and
a carrying assist member disposed, apart from the developer transfer path, to face the developer carrying surface in a third position upstream relative to the second position in the second direction,
wherein the carrying assist member is configured to, when a predetermined voltage is applied thereto, generate an electric field, under which the charged development agent heads for the developer carrying surface, between the carrying assist member and the developer carrying member.

5. The image forming apparatus according to claim 4,
wherein the developer supply device further comprises a retrieving member disposed to face the developer carrying surface in a fourth position downstream relative to the first position and upstream relative to the third position in the second direction, and
wherein the retrieving member is configured to, when a predetermined voltage is applied thereto, to generate an electric field, under which the charged development agent is attracted toward the retrieving member, between the retrieving member and the developer carrying surface and to retrieve the development agent left on the developer carrying surface after passing through the first position.

6. The developer supply device according to claim 1,
wherein the carrying assist member comprises a roller-shaped member configured to rotate around an axis parallel to the first direction.
